(19) United States
(12) Patent Application Publication
(10) Pub. No.: US 2009/0301423 A1
(43) Pub. Date: Dec. 10, 2009

(54) Intake manifold

(75) Inventor: Shigehiro Usuda, Nishikamo-gun (JP)

Correspondence Address: OLIFF & BERRIDGE, PLC, P.O. BOX 320850, ALEXANDRIA, VA, 22320-4850, US

(73) Assignee: TOYOTA JIDOSHA KABUSHIKI KAISHA, Toyota-shi (JP)

(21) Appl. No.: 12/308,408

(22) PCT Filed: Jul. 3, 2007
(86) PCT No.: PCT/IB2007/001817

§ 371 Date: Dec. 15, 2008

(30) Foreign Application Priority Data
Jul. 6, 2006 (JP) 2006-186360

(51) Int. Cl. F02M 35/10

(52) U.S. Cl. 123/184.42

(57) ABSTRACT

An intake manifold (1) having a plurality of branch pipes (11) that link intake ports of an internal combustion engine and a surge tank (2) has rib portions (4) that extend from a surge tank surface (2a) to the branch pipes (11) and that link the surge tank surface (2a) and the branch pipes (11). In the surge tank (2), at least a portion of the surge tank surface (2a) that intersects with a center line of each branch pipe (11) faces an outer peripheral surface of each branch pipe (11). The rib portions (4) include at least parallel portions (4a) that extend substantially parallel with a center line of each branch pipe (11).

### BACKGROUND OF THE INVENTION

1. Field of the Invention

The invention relates to an intake manifold for taking external air into an internal combustion engine.

2. Description of the Related Art

A technology in which an intake manifold having a plurality of branch pipes that correspond in number to the cylinders of an internal combustion engine is provided between the input ports of the internal combustion engine and the surge tank so that the air introduced into the surge tank is taken into the input ports of the internal combustion engine through the intake manifold is disclosed, for example, in Japanese Patent No. 2500856.

As an example of the intake manifold as mentioned above, an intake manifold that is made of resin, for example, by injection molding, so as to reduce the weight thereof is disclosed, for example, in Japanese Patent Application Publication No. JP-A-11-182367.

However, according to the above-described intake manifold, a phenomenon in which exhaust pulses blow back toward the intake manifold side at the times of overlap of an exhaust valve and an intake valve of the internal combustion engine occurs. In the blowback phenomenon, the pulses, propagating through the intake manifold, strike and vibrate a surge tank surface of the surge tank that is linked to the intake manifold, and therefore produce noise.

The above-described phenomenon is likely to occur under an operation condition of 2000 rpm or lower where the flow velocity at the intake side is relatively slow and the valve overlap is great. Under this condition, the levels of vibration and noise are particularly great. Furthermore, with the recently prevailing variable valve timing technology, the increased degree of freedom in valve timing is also considered to be one of the factors that produce noise.

### SUMMARY OF THE INVENTION

It is an object of the invention to provide an intake manifold able to restrict the noise produced by exhaust pulses striking a surge tank surface of a surge tank and thus vibrating the surge tank surface.

An intake manifold according to a first aspect of the invention has a plurality of branch pipes that connect intake ports of an internal combustion engine and a surge tank, and has a rib portion that extends from a surge tank surface of the surge tank to the branch pipes and that links the surge tank surface and the branch pipes. In the surge tank, at least a portion of the surge tank surface that intersects with a center line of each branch pipe faces an outer peripheral surface portion of each branch pipe. Furthermore, the rib portion includes at least a parallel portion that extends substantially parallel with the center line of each branch pipe.

According to the first aspect of the invention, since at least the parallel portion that extends substantially parallel with the center line of each branch pipe is provided as a rib portion, the parallel portion restrains the surge tank surface from vibrating in the directions of the branch pipes.

In the first aspect, the parallel portion may be provided on an extension line of the center line of each branch pipe which intersects with the surge tank surface. The parallel portion may also be provided perpendicularly to the surge tank surface.

In the forgoing aspect, the intake manifold may further include a second rib portion that extends substantially parallel with the surge tank surface. According to the aforementioned constructions, the second rib portion restrains the vibrations of the surge tank surface in the planar directions. The constructions are especially effective in the case where the parallel portion is not provided perpendicularly to the surge tank surface.

An intake manifold according to a second aspect of the invention has a plurality of branch pipes that connect intake ports of an internal combustion engine and a surge tank, and has a rib portion that extends from a surge tank surface to the branch pipes and that links the surge tank surface and the branch pipes. In the surge tank, at least a portion of the surge tank surface that intersects with a center line of each branch pipe faces an outer peripheral surface of each branch pipe, and the rib portion has at least a portion that extends substantially parallel with the surge tank surface.

In the foregoing aspects of the invention, the intake manifold may be made of a resin. Therefore, weight reduction of the intake manifold can be achieved. If the intake manifold is made of a resin, the intake manifold is apt to vibrate. Therefore, the aforementioned rib portion effectively operates in restraining vibrations.

In the foregoing aspects, the rib portion, the surge tank and the branch pipes may be unitarily formed. Therefore, the number of component parts can be reduced.

In the foregoing aspects, the intake manifold may further include a movable valve that changes an air channel length in the intake manifold. In the construction where the movable valve is provided, the surge tank surface may intersect with the center line of a branch pipe when the air channel length is set relatively long.

According to the invention, the rib portion restrains vibrations of the surge tank surface from being caused when the surge tank surface is struck by exhaust pulses propagating through the intake manifold due to the phenomenon in which exhaust pulses blow back toward the intake manifold at the times of overlap of an exhaust valve and an intake valve in the internal combustion engine. Thus, the production of noises caused by the blowback phenomenon can be prevented.

### BRIEF DESCRIPTION OF THE DRAWINGS

The foregoing and further objects, features and advantages of the invention will become apparent from the following description of example embodiments with reference to the accompanying drawings, wherein like numerals are used to represent like elements and wherein:

FIG. 1 is a perspective view showing an external shape of an intake manifold in accordance with the invention;

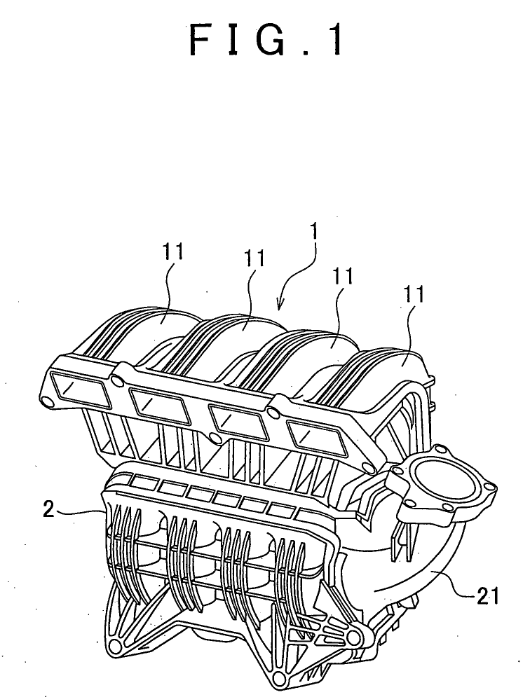

FIG. 2 is a sectional view showing a concrete construction of the intake manifold of the invention; and

FIG. 3 is a sectional view showing another example of a rib portion of the intake manifold of the invention.

### DETAILED DESCRIPTION OF THE EXAMPLE EMBODIMENTS

Hereinafter, embodiments of the invention will be described with reference to the drawings.

An intake manifold 1 is provided for leading the air taken into a surge tank 2 through an intake passageway 21 to intake ports of an internal combustion engine, and has a plurality of branch pipes 11 that correspond in number to the cylinders of the internal combustion engine. Specifically, an end of each branch pipe 11 is connected to the surge tank 2, and another end thereof is linked to a corresponding one of the intake ports of the internal combustion engine.

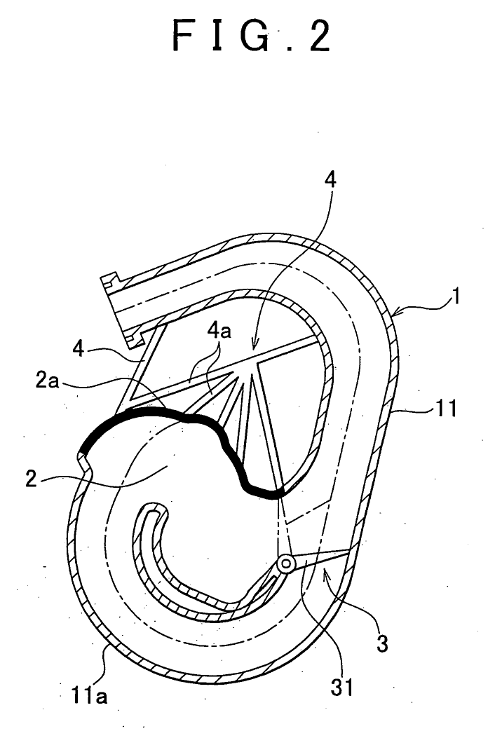

Furthermore, each branch pipe 11 is provided with a variable intake length mechanism 3 as shown in FIG. 2. The variable intake length mechanism 3 is provided for adjusting the length of air channel provided by the intake manifold 1 that introduces air from the surge tank 2 into the intake ports of the internal combustion engine, and is equipped with a movable valve 31 that is easily pivotable between a position shown by a solid line and a position shown by a two-dot chain line in FIG. 2.

Therefore, by setting the movable valve 31 at the position shown by the solid line in FIG. 2, the air introduced into the surge tank 2 is introduced into the intake port through a short channel (high-speed side). By setting the movable valve 31 at the position shown by the two-dot chain line in FIG. 2, the air introduced into the surge tank 2 is introduced into the intake port through a long channel (low-speed side) 11a.

In the intake manifold 1 of the invention constructed of the foregoing members, the surge tank 2 is disposed so that a surge tank surface 2a that intersects with a center line of the long channel 11a of each branch pipe 11 is located at such a position as to face a side surface portion of each branch pipe 11 which is located toward a downstream side end. By disposing the surge tank 2 in this manner, the surge tank 2 and the branch pipes 11 can be disposed sufficiently adjacent to each other. A suitable number of rib portions 4 are provided between the branch pipes 11 and the surge tank surface 2a of the surge tank 2 that are disposed adjacent to each other.

The rib portions 4 include parallel portions 4a that extend substantially parallel with the center lines of the branch pipes 11, and the parallel portions 4a and the other rib portions 4 are suitably linked to one another.

Since the surge tank 2 is disposed relative to the branch pipes 11 as described above and the surge tank surface 2a and the branch pipes 11 are linked by the rib portions 4 to firmly hold the surge tank surface 2a, it is possible to restrain vibrations of the surge tank surface 2a from being caused when the surge tank surface 2a is struck by exhaust pulses propagating through the branch pipes 11 of the intake manifold 1 due to the phenomenon in which exhaust pulses blow back toward the intake manifold 1 at the times of overlap of an exhaust valve and an intake valve in the internal combustion engine. Thus, the production of noises can be prevented.

In this construction, since the rib portions 4 include the parallel portions 4a that extend substantially parallel with the center lines of the branch pipes 11, the parallel portions 4a restrain the surge tank surface 2a from vibrating in the directions of the branch pipes 11.

Furthermore, since the surge tank surface 2a and the branch pipes 11 are disposed sufficiently adjacent to each other, the entire device can be made compact and lightweight. Still further, since the surge tank surface 2a and the branch pipes 11 are linked by the rib portions 4, the rigidity of the branch pipes 11 as well as the reinforcement of the surge tank surface 2a can be improved, so that the rigidity of the intake manifold in the up-down direction can be enhanced.

Furthermore, since the production of noise by vibrations of the surge tank surface 2a can be sufficiently restrained, the sound absorbing material required can be reduced, and the cost can be lowered.

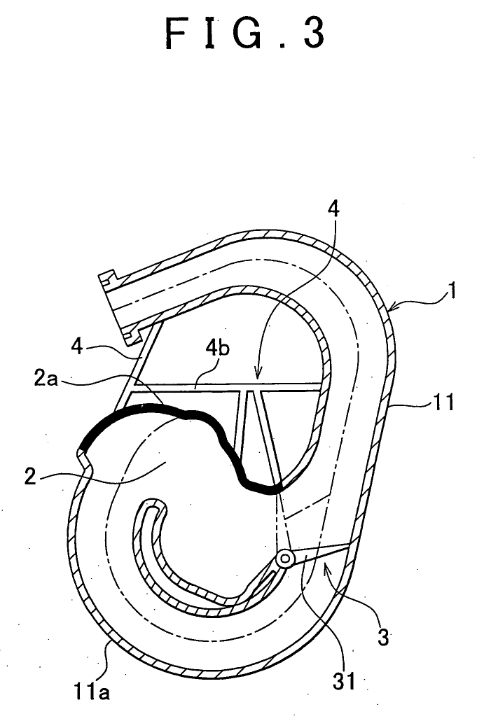

Rib portions 4 shown in FIG. 3 include second rib portions 4b that extend substantially parallel with the surge tank surface 2a. The second rib portions 4b can restrain vibrations of the surge tank surface 2a in the planar directions. Therefore, in the case where the parallel portions 4a are not provided perpendicularly to the surge tank surface 2a, the formation of the second rib portions 4b as described above is very effective.

The second rib portions 4b extending substantially parallel with the surge tank surface 2a may also be provided in addition to the parallel portions 4a that are provided perpendicularly to the surge tank surface 2a.

The intake manifold 1 constructed as described above may be a resin-made intake manifold that is, for example, molded by injection molding. If the intake manifold 1 is made of resin, the weight of the intake manifold 1 can be reduced, but the resin-made intake manifold is apt to vibrate. Therefore, the rib portions 4 including the parallel portions 4a and the second rib portions 4b effectively operate to restrain such vibrations. Furthermore, if the rib portions 4, the surge tank 2 and the branch pipes 11 are unitarily formed (integrally molded) of a resin or the like, the number of component parts can be reduced.

Incidentally, the invention is not limited to the foregoing embodiments, but may also be modified in various manners within the scope of the invention.

For example, although in the foregoing embodiments, the branch pipes 11 are provided with the variable intake length mechanism 3, the variable intake length mechanism 3 may be omitted.

Furthermore, the number of the rib portions 4 may be suitably determined in accordance with the circumstances.

1.-3. (canceled)

4. The intake manifold according to claim 9, further comprising a second rib portion that extends substantially parallel with the surge tank surface.

5. (canceled)

6. The intake manifold according to claim 9, wherein the intake manifold is made of a resin.

7. The intake manifold according to claim 9, wherein the rib portion, the surge tank and the branch pipes are unitarily formed.

8. The intake manifold according to claim 9, further comprising a movable valve that changes an air channel length in the intake manifold, wherein the surge tank surface intersects with the direction in which the axis line of each branch pipe extends when the air channel length is set relatively long.

9. An intake manifold comprising:
a surge tank;
a plurality of branch pipes connecting intake ports of an internal combustion engine and the surge tank, wherein the surge tank has a surge tank surface that intersects with a direction in which an axis line of each branch pipe extends; and
a rib portion that extends from the surge tank surface to the branch pipes and that links the surge tank surface and the branch pipes.

10. (canceled)

11. The intake manifold according to claim 9, wherein the rib portion extends in the direction in which the axis line of each branch pipe extends.

12. An intake manifold comprising:
a surge tank;
a plurality of branch pipes connecting intake ports of an internal combustion engine and the surge tank, wherein the surge tank has a surge tank surface that faces an end of each branch pipe, which is connected to the surge tank; and
a rib portion that extends from the surge tank surface to the branch pipes and that links the surge tank surface and the branch pipes.

13. The intake manifold according to claim 12, wherein the rib portion extends in a direction in which an axis line of each branch pipe extends.

14. The intake manifold according to claim 12, further comprising a second rib portion that extends substantially parallel with the surge tank surface.

15. The intake manifold according to claim 12, wherein the intake manifold is made of resin.

16. The intake manifold according to claim 12, wherein the rib portion, the surge tank and the branch pipes are unitarily formed.

17. The intake manifold according to claim 12, further comprising a movable valve that changes an air channel length in the intake manifold, wherein the surge tank surface intersects with a direction in which an axis line of each branch pipe extends when the air channel length is set relatively long.

18. An intake manifold comprising:
a surge tank;
a plurality of branch pipes connecting intake ports of an internal combustion engine and the surge tank, wherein the surge tank has a surge tank surface that is struck by an exhaust pulse that blows back from the internal combustion engine to the branch pipe; and
a rib portion that extends from the surge tank surface to the branch pipes and that links the surge tank surface and the branch pipes.

19. The intake manifold according to claim 18, wherein the rib portion extends in a direction in which an axis line of the branch pipe extends.

20. The intake manifold according to claim 18, further comprising a second rib portion that extends substantially parallel with the surge tank surface.

21. The intake manifold according to claim 18, wherein the intake manifold is made of a resin.

22. The intake manifold according to claim 18, wherein the rib portion, the surge tank and the branch pipes are unitarily formed.

23. The intake manifold according to claim 18, further comprising a movable valve that changes an air channel length in the intake manifold, wherein the surge tank surface intersects with a direction in which an axis line of each branch pipe extends when the air channel length is set relatively long.
